(19) United States
(12) Patent Application Publication
(10) Pub. No.: US 2006/0105730 A1
(43) Pub. Date: May 18, 2006

(54) Antenna arrangement for multi-input multi-output wireless local area network

(76) Inventors: Isabella Modonesi, Utrecht (NL); Tim Schenk, HL Eindhoven (NL); Xiao-Jiao Tao, Twente (NL)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 10/991,935

(22) Filed: Nov. 18, 2004

(51) Int. Cl. H04B 7/02

(52) U.S. Cl. 455/273; 455/277.1

(57) ABSTRACT

Line-of-sight and non-line-of-sight channel conditions are efficiently and optimally handled in a MIMO wireless network by coupling two or more dual polarization antennas together through a controller that selects a prescribed combination of antenna outputs in response to determination of the existence of a particular channel condition. In this manner, the controlled antenna array develops a suitable level of signal discrimination (decorrelation), whether or not the channel condition provides it. In one embodiment, two dual polarized antennas are separated from each other and have their dual polarization output signals coupled to the same switching element so that the orthogonal outputs from an antenna are available at the same switching element. A controller selects a particularly polarized output signal from each antenna based on a predetermined criterion.

### BACKGROUND OF THE INVENTION

1. Field of the Invention

This invention relates to an antenna arrangement for use in a wireless network and, more particularly, to the controlled use of an array of dual-polarized antennas to improve reception of line-of-sight signals in a wireless network such as a local area network.

2. Description of the Related Art

Multiple input, multiple output (MIMO) systems are well designed to exploit the space diversity offered by multiple channels between a transmitter and receiver in a wireless network. Independent multipath propagation insures the existence of space diversity and the expected performance of the MIMO system. Multipath signal components virtually increase the antenna array aperture and assure that the channel matrix is invertible. A desirable multipath condition for MIMO exists when the transmitter and receiver are operating on a non-line-of-sight channel. MIMO is susceptible to a significant degradation of performance when the transmitter and receiver operate over a line-of-sight channel, where generally only one dominant path exists.

In networks such as wireless local area networks (WLANs) and the like, it is expected that there are often occasions where the transmitter and receiver operate over a line-of-sight channel. When this condition occurs, the received signals are spatially highly correlated and extremely difficult, if not impossible, to separate. Mathematically, the line-of sight condition causes the MIMO system to operate poorly because the channel matrix is ill-conditioned and rank deficient, that is, non-invertible.

For such MIMO systems in a line-of-sight environment, it has been suggested that the plurality of receive antennas be separated from each other by several multiples of the operating wavelength in order to increase the antenna array aperture. See, for example, G. D. Durgin et al., “Effects of multipath angular spread on the spatial cross-correlation of received voltage envelopes”, in Proc. of the 49th IEEE Vehicular Technology Conf. 1999, vol. 2, pp. 996-1000. In contrast to the non-line-of-sight condition wherein the antenna array aperture is virtually increased, the proposed solution of separating the individual antennas in the array to deal with a line-of-sight condition actually increase the overall dimension of the array.

Other solutions have applied polarization diversity to solve this problem in the line-of-sight environment. See, for example, C. B. Dietrich, Jr. et al., “Spatial, Polarization, and Pattern Diversity for Wireless Handheld Terminals,” in IEEE Transactions On Antennas And Propagation, Vol. 49, No. 9, pp. 1271-1281, September 2001. But there has been no proposal in the prior art that permits a MIMO wireless network to operate efficiently and optimally in both a line-of-sight and a non-line-of-sight channel condition. In effect, there has been no proposal that provides sufficient spatial resolution when operating in either the line-of-sight or the non-line-of-sight channel environment.

### SUMMARY OF THE INVENTION

Line-of-sight and non-line-of-sight channel conditions are efficiently and optimally handled in a MIMO wireless network by coupling two or more dual polarization antennas together through a controller that selects a prescribed combination of antenna outputs (received signal polarizations) in response to determination of the existence of a particular channel condition. In this manner, the controlled antenna array develops a suitable level of signal discrimination (decorrelation), whether or not the channel condition provides it.

In one embodiment, two dual polarized antennas are separated from each other and have their dual polarization output signals coupled to the same controllable selection element so that the orthogonal outputs from an antenna are available for selection at the same switching element. A controller selects a particular combination of polarized output signals from the antennas based on a predetermined criterion. In one exemplary criterion, the controller can receive a signal from the transmitter directing that the antenna outputs in one polarization (e.g., H-pol) or the other (e.g., V-pol) be selected by the receiver. In another exemplary criterion, the controller measures a characteristic of the received signal such as received power when the antenna outputs from a first orthogonal polarization are selected; then the controller selects the second orthogonal polarization state for the antenna outputs and measures a characteristic of the received signal such as received power when the antenna outputs from the second orthogonal polarization are selected; and the controller compares the two sets of characteristics to determine which antenna output setting provided the best response. In still another exemplary criterion, the transmitter and receiver controllers go through a coordinated series of selections in order to determine which antenna output setting provided the best response.

### BRIEF DESCRIPTION OF THE DRAWINGS

A more complete understanding of the invention may be obtained by reading the following description of specific illustrative embodiments of the invention in conjunction with the appended drawings in which:

FIG. 1 shows a simplified system diagram for an exemplary wireless system; and

FIGS. 2 through 4 show an aperture coupled patch antenna arrangement realized in accordance with the principles of the present invention

It is to be noted, however, that the appended drawings illustrate only typical embodiments of this invention and are therefore not to be considered limiting of its scope, for the invention may admit to other equally effective embodiments. Where possible, identical reference numerals have been inserted in the figures to denote identical elements.

### DETAILED DESCRIPTION

The present invention applies to products based on wireless local area network (WLAN) standards IEEE 802.11a/g and future WLAN standard IEEE 802.11n. According to the principles of the present invention, it is possible to overcome the problem caused by Line-of-Site (LOS) communication in MIMO based WLAN networks. This low cost solution then provides a significant performance increase when communication in the LOS regime is experienced. Moreover, this invention does not degrade performance when communication is in the non-LOS regime. The present invention can be used to supplement standards-compliant products without impairing standards compatibility of the products.

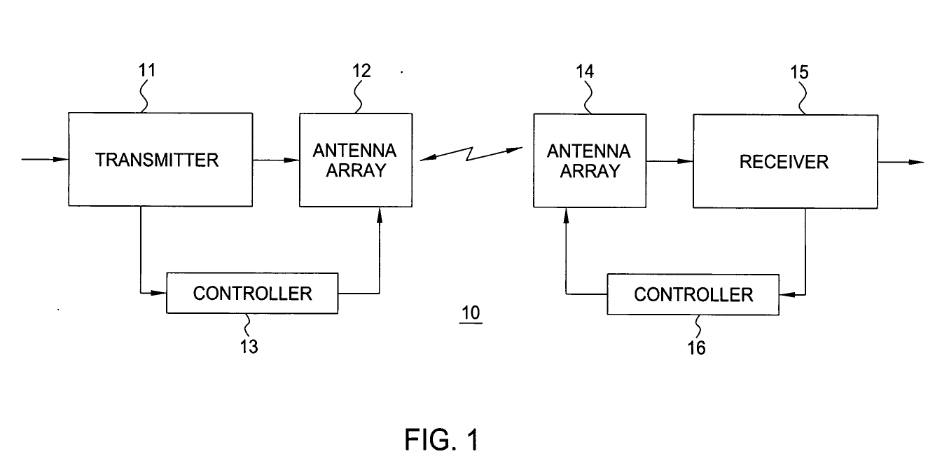

FIG. 1 shows a simplified block diagram for a wireless system including, for example, a wireless local area network (WLAN). It shows a transmitter site communicating with a receiver site. In practice, the transmitter and receiver sites are generally transceiver sites wherein each site performs the dual role of transmission and reception. For ease of explanation, the system is shown in FIG. 1 as a unidirectional system rather than the expected bidirectional system. The transmitter site includes transmitter 11, antenna array 12 and controller 13; the receiver site includes receiver 15, antenna array 14 and controller 16. Both the transmitter and receiver are well known in the art and will not be discussed in detail herein. Standards compliant devices for WLAN applications and other MIMO devices are contemplated for use herein.

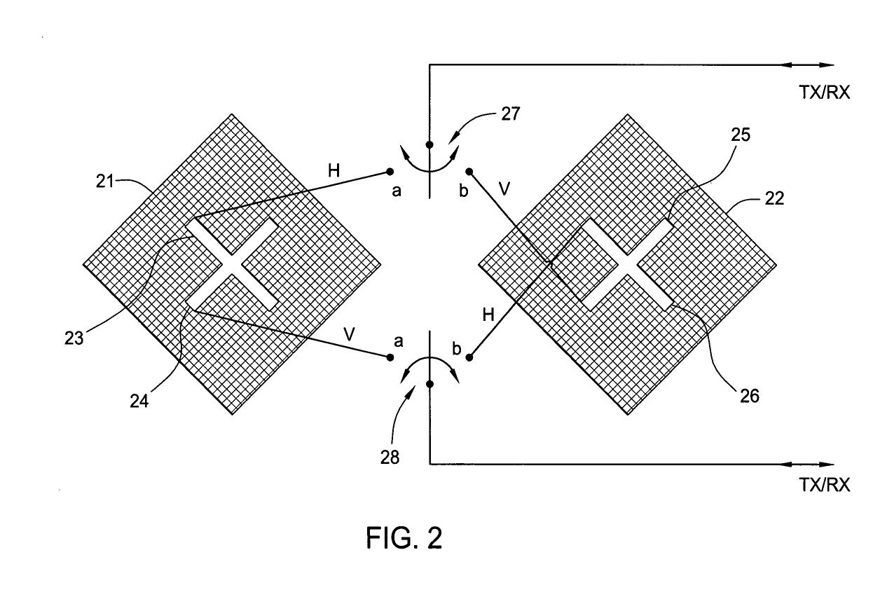

Antenna arrays 12 and 14 are preferably identical or substantially similar. In an exemplary embodiment, two dual polarization antennas are used in each array as shown in FIGS. 2-4. The antennas depicted in the figures are aperture coupled patch antennas. Dipole antennas are also contemplated for use herein.

A controller 13 is coupled between the transmitter and the antenna array to control the antenna array 12. Similarly, controller 16 is coupled between the transmitter and the antenna array to control the antenna array 14. The aspects of the controller operation will be discussed in more detail below. It is important at this time to understand that the controller is used to determine the combination of transmitted or received polarizations that maximizes the performance of the system, especially in a LOS communication environment.

Before presenting additional details about the aspects of the present invention, it is important to understand the issues and difficulties that arise as a result of a line-of-sight condition in the system.

Multipath has long been regarded as a major problem to communication systems. But this problem tends to arise because of the system design and operating characteristic, namely, a narrow-band system and inherent fading effect. In certain circumstances, though, multipath may be an advantageous property. In a wideband system, signals have high resolution in time domain thereby allowing a large number of subpaths to be resolved and beneficially added up, while only a small number of subpaths with their time-delay-difference less than the reciprocal of the transmission bandwidth impact communications. For a MIMO system, multipath virtually increases the array aperture (size). Every specular reflection in effect creates a virtual receiver. In the indoor environment, a spatial null pattern will likely become a spot shape due to multipath instead of a pencil shape expected in the free space propagation case.

Nevertheless the real-life environment with less strong multipath components or even none may be encountered. This is often modeled as the Ricean fading or referred to as the line-of-sight (LOS) situation. Unfortunately, the LOS condition impairs the performance of a MIMO system. This can be understood from the following example. Consider a free space propagation environment (an extreme case of Ricean fading with k→∞) in which two transmitters are located on the boresight of the receiver array. To suppress the signals from the second transmitter at the receivers, the demultiplexing function of MIMO will adjust its weights to, say [0.5, −0.5] in this case, placing a null at the direction of the second transmitter. Since the first transmitter is from the same direction as the second transmitter, the signals from the first transmitter will be nulled out as well. The channel matrix,

$$H = [ \begin{matrix}1 & 1 \\ 1 & 1\end{matrix} ]$$

is singular. The same holds true for the so-called key-hole effect where the waves from transmitters propagate through a very small hole to reach receivers. The MIMO operation would place a spatial null at this point. Again the channel matrix is rank-deficient (degenerate) because of a many-to-one and one-to-many mapping,

$$H = [ \begin{matrix}{h}_{1} \\ ⋮ \\ {h}_{Rx}\end{matrix} ] [ \begin{matrix}{g}_{1} & ⋯ & {g}_{Tx}\end{matrix} ]$$

The above examples point out the lack of spatial diversity in the LOS condition. If, however, both transmitters are positioned to be in parallel communication with the receiver array, spatial diversity is achieved. The spatial resolution, i.e. difference in the direction of arrival (DOA), nearly reaches its maximum. After placing a null at direction of the second transmitter, the array magnitude response is

$$P ( θ ) = \vert sin ( \frac{π d}{λ} sin θ ) \vert$$

$$with$$

$$d = {d}_{Rx}$$

$$θ = arctan \frac{{d}_{Tx}}{r}$$

where d_{Rx}, d_{Tx} and r denotes the receiver aperture, the transmitter spacing, and the distance between the first transmitter and the center of the receiver array, respectively. Any source near the spatial null plane will be attenuated. The signal-to-noise ratio (SNR) degradation, defined as 20 log₁₀ P(θ), of the first transmitter is listed in Table 1 below for different aperture settings at both the transmitters and the receivers. It should be noted that the distance between the second transmitter and the center of receiver array is 100 wavelengths (about 12.5 meter at 2.4 GHz). A spacing of 4 wavelengths, about the 50 cm., is possibly the maximum available size of the array because it is the maximum diagonal size of a notebook computer lid. Ignoring the effects of propagation loss, it is seen that there is a 6 dB increase in SNR for every doubling in the receiver aperture or in the transmitter spacing. As a result, one can conclude that MIMO does not work in the LOS environment.

TABLE 1
SNR degradation of the desired signal
due to 2 × 2 MIMO demultiplexing

| Range = 100 wavelength | | | | | |
|---|---|---|---|---|---|
| SNR loss after demultiplexing | | Transmitter spacing (d_{Tx} in wavelength) | | | |
| (dB) | | 0.5 | 1 | 2 | 4 |
| Receiver aperture | 0.5 | −42.1 | −36.1 | −30.1 | −24.1 |
| (d_{Rx} in wavelength) | 1 | −36.1 | −30.1 | −24.1 | −18.1 |
| | 2 | −30.1 | −24.1 | −18.1 | −12.1 |
| | 4 | −24.1 | −18.1 | −12.1 | −6.3 |

Given the space limitations of the WLAN system, it is possible to address the LOS environment by using the anisotropic characteristics of each antenna element, including polarization diversity and pattern diversity. Use of a simple polarization and radiation pattern could achieve the necessary performance. In order to understand this, consider the same 2×2 MIMO system described above where additional orthogonal polarization is employed at both the transmitters and the receivers. That is, there is a 90° difference in polarization between the two antenna elements at each transmitter and at each receiver. FIG. 2 depicts one exemplary embodiment of a patch antenna having orthogonal elements. In order to null out the second transmitter, the weights adjusted by the demultiplexing function will be,

$$[ \frac{sin β}{sin β + cos β} , \frac{cos β}{sin β + cos β} ]$$

where β is the angular offset between the signals transmitted by the first transmitter and received by the first receiver. The array magnitude response can then be written as,

$$P ( θ ) = \vert \frac{{sin}^{2} β}{sin β + cos β} + \frac{{cos}^{2} β}{sin β + cos β} exp ( ⅈ \frac{2 π d}{λ} sin θ ) \vert$$

Even if the first transmitter are from the same direction as the second transmitter, (i.e. θ=0) and

$$P ( θ ) = \frac{1}{\vert sin β + cos β \vert} , where \frac{1}{\sqrt{2}} \leq P ( θ ) \leq 1.$$

Thus the SNR degradation when polarization diversity is utilized is −3 dB in the worst case.

After taking spatial diversity loss into account, it has been discovered by us that the best possible way to guarantee good performance from a MIMO system in both the LOS and the NLOS environments is to construct an antenna array with at least two dual-polarized antenna elements and at least two switches coupled to the antenna elements of each polarization pair. The switches permit all possible combinations of received signal polarizations to be selected by a controller at the receiver (or the transmitter) that adapts the antenna feeds appropriately for the different channel conditions such as LOS and NLOS. An exemplary configuration for aperture coupled patch antennas is shown in FIG. 2. A similar antenna arrangement is contemplated for use in the transmitter. It is contemplated that other antenna designs such as slanted dipole elements can be utilized in the present invention.

In accordance with the principles of the present invention, an antenna array is coupled to one or more controllable switching elements for selecting the combination of signal polarizations that are received and transmitted. In order to simplify the presentation of this material, the description will be focused upon the antenna array 14 at the receiver. It will be appreciated by persons skilled in the art that the operation of both antenna arrays is substantially the same. In each of FIGS. 2-4, the notation “Tx/Rx” with accompanying dual arrows is shown at one end of the lead attached to each switch. This notation indicates the inward flow of signals toward the switches when the array is employed at the transmitter (Tx) site. Similarly, the notation indicates outward flow of signals away from the switches when the array is employed at the receiver (Rx) site. It should also be understood that

FIG. 2 shows an exemplary embodiment of a controllable antenna array in accordance with the principles of the present invention. The array comprises two dual polarization, aperture coupled patch antennas and two controllable switch elements. Although not shown in the figures, controller 16 controls the operation of switches 27 and 28. Switches 27 and 28 can be realized by standard switch elements as shown in FIG. 1, multiplexer elements, selector elements and the like, provided that the elements are controllable and responsive to an applied control signal.

Patch antenna 21 includes orthogonally polarized elements 23 and 24. Element 23 is designated the horizontally polarized element (H-pol), while element 24 is designated the vertically polarized element (V-pol). Patch antenna 22 includes orthogonally polarized elements 25 and 26. Element 26 is designated the horizontally polarized element (H-pol), while element 25 is designated the vertically polarized element (V-pol). Aperture coupled patch antenna are well known in the art and their composition and fabrication will not be discussed herein.

Switches 27 and 28 are selectively coupled to a particular polarization available from one of the two antennas. Switch 27 can be coupled to the H-pol antenna element from antenna 21 at the “a” position of the switch or to the V-pol antenna element from antenna 22 at the “b” position of the switch. Similarly, switch 28 can be coupled to the V-pol antenna element from antenna 21 at the “a” position of the switch or to the H-pol antenna element from antenna 22 at the “b” position of the switch. Typically, the controller selects one polarization from each antenna and generally the polarization will be the same. For example, the controller will select the vertically polarized antenna elements by connecting switch 27 to the “b” position and by connecting switch 28 to the “a” position. As a result, the signals received by each antenna in the vertical polarization will be output by the antenna array to the receiver 15 for MIMO processing.

Although it is preferred that the array output signals from the same polarization, it is contemplated that the controller will select switch positions that cause orthogonal polarizations to be output by the antenna array. It should be understood that this is even preferable in the LOS environment.

Two antennas are shown in each of FIGS. 2-4. But it is contemplated that many more antennas could be used in the antenna array. As more antennas are added to the array, the spatial distribution of the antennas is to be considered. A linear array pattern is contemplated as shown in the figures, but other array orientations such as circular are also possible. Generally, the distribution pattern is selected to minimize the overall footprint (area) of the antenna array and maintain a desired size common in the industry. The pattern distribution and antenna types are expected to be substantially identical throughout the entire system for all transmitters and receivers.

One additional factor that can contribute to the size of the array is the antenna separation. Generally, antenna separation should be maximized. But it is shown in the art that an acceptable and even desirable separation is at least λ/2, where λ denotes the wavelength. For operation in the 5 GHz band, λ is 5 cm. In the 2 GHz band, λ is about 15 cm. From a practical standpoint, antenna separation is necessary for decreasing the correlation of the transmitted and received signals in the NLOS MIMO mode.

As described above, the antennas in the array can be orthogonal dipoles or dual polarized aperture coupled patch elements. For the wireless applications as described herein, the dimensions of each individual patch antenna is preferably 0.37λ×0.37λ and the dimensions of each orthogonal dipole is preferably 0.5λ. Since IEEE 802.11a based WLAN systems operate in the 5 GHz band, λ is about 6 cm. Since UMTS/IMT200 and IEEE 802.11g based systems operate in the 2 GHz band, λ is about 15 cm. Although the results are expected to be less than optimum, it is contemplated that other dimensions such as a quarter wavelength for dipole antennas may be utilized herein.

Antenna alignment is another consideration. While it is ideal to have each set of identical orthogonally polarized antenna elements in the same plane, some misalignment is contemplated. In fact, if the alignment of the same polarization elements were misaligned by as much as 90°, then the misalignment could be simply overcome by switching polarity designations for the misaligned elements.

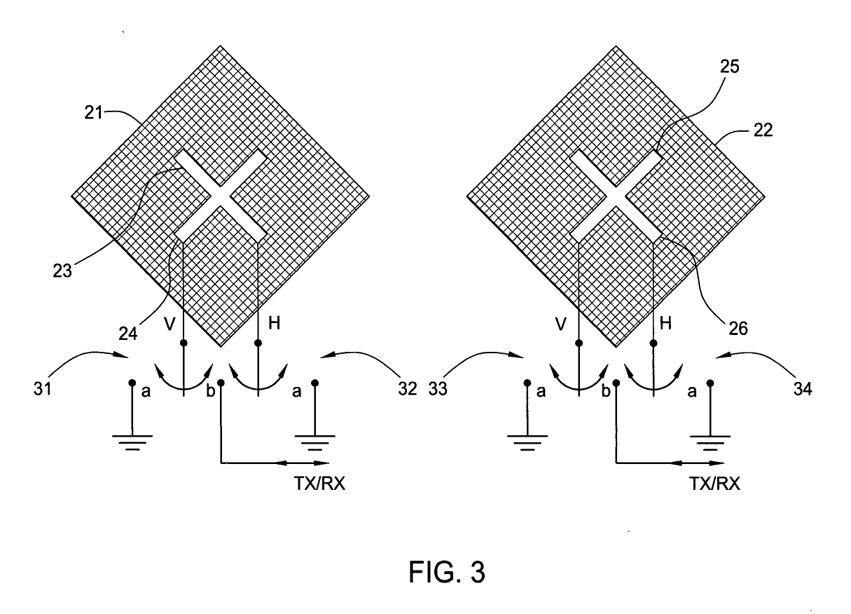

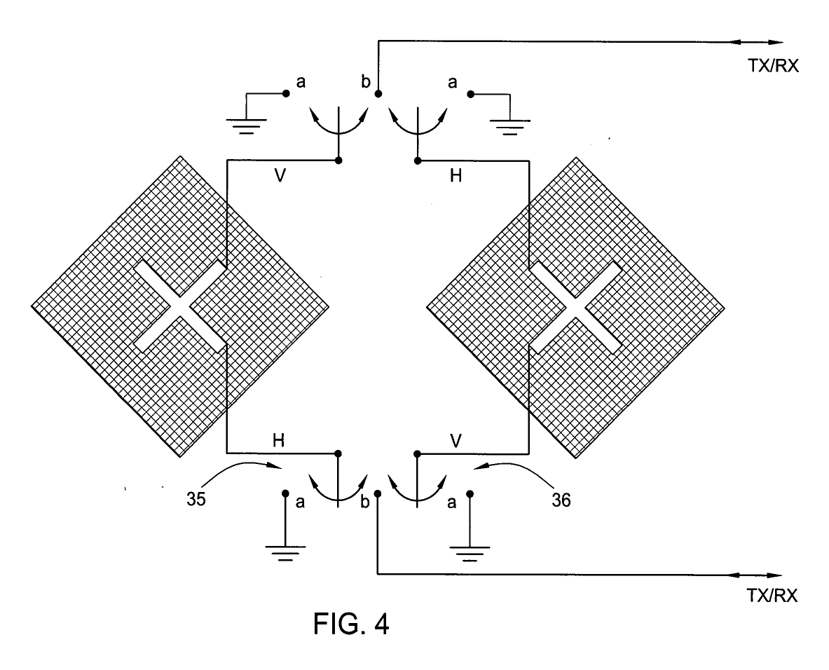

Arrangements for transmitting (and receiving) both orthogonal polarizations from the same antenna are shown in FIGS. 3 and 4. In those illustrative embodiments, each switch (elements 31-34 in FIG. 3 and elements 35-38) has its poles controllably switchable. For example when switch 31 is in position a, switch 32 can be in position b or in the far position also labeled as position a. When it is desired to transmit or receive signals in both polarizations on the same antenna, the controller sends a signal to the switches coupled to antenna to cause both switches to be in position b. Obviously, when only one polarization is desired to or from the antenna, then the controller sends a signal causing one switch to be in position a while the other switch is in position b. The arrangements shown in FIGS. 3 and 4 can be used by the transmitter when the antenna configurations at the various receivers are unknown and possibly different from the transmitter antenna configuration.

Controller 16 monitors signals received by receiver 15 and responsively selects the particular combination of antenna outputs (polarizations) that develop sufficient signal discrimination for MIMO WLAN to operate, whether or not the transmission channel provides that discrimination. In the NLOS environment, sufficient discrimination occurs as a result of the signal multipath. In the LOS environment, as discussed above, there is insufficient multipath to discriminate one received signal from the other at the two receive antennas. By using the controllably switchable antenna array 14 shown in the FIGs. With the controller, it is possible to select a set of antenna outputs (polarizations) that provides sufficient signal discrimination or decorrelation and thereby improves the MIMO system performance when a LOS environment is encountered.

In one exemplary embodiment, controller 16 receives a signal from the transmitter that instructs controller 16 to select a particular combination of antenna outputs. This could be an initialization procedure or it could be based on the transmitter antenna pattern being employed at the time. For example, controller 16 can be directed to select both H-pol antenna outputs or both V-pol antenna outputs or a combination of the two either from the same antenna or from the separate antennas. After controller 16 sends the control signals to the switches to cause the appropriate antenna outputs to appear at the receiver, controller 16 monitors a characteristic of the received signals to measure the system performance. If the controller observes and measures that by switching the combination of antenna outputs to the requested state results in degraded performance, then the controller 16 can initiate a change to new combination of antenna outputs that is anticipated to provide improved performance. Although other measures of performance can be observed, the preferred measure observed by the controller is the received signal output power.

In many MIMO systems, the period of time corresponding to reception of the signal preamble can be used for training on the channel condition. It is contemplated that the controller 16 can perform its monitoring and control switching functions during that period in order to avoid interfering with the payload or other portions of the received signals.

As described above, controller 16 monitors one or more characteristics of the received signals. Even without a preliminary instruction from the transmitter, controller 16 generates controls signals to switch the combination of antenna outputs to a desired state based on the observed results from monitoring the signal performance. By initiating a switch from one antenna output combination to another, the controller can observe potentially different levels of performance and take corrective action by controllably switching the antenna outputs to the combination that provides the best level of performance.

While the foregoing is directed to embodiments of the present invention, other and further embodiments of the invention may be devised without departing from the basic scope thereof, and the scope thereof is determined by the claims that follow.

1. A wireless antenna arrangement comprising:
at least first and second antennas spaced apart from each other by a predetermined distance, each antenna having first and second orthogonal elements for receiving first and second polarizations of a signal, respectively;
a controllable selection element coupled to each orthogonal element of the at least first and second antennas, the controllable selection element also including at least first and second output ports and being responsive to a control signal for connecting a desired polarization of the signal received by the first antenna to the first output port and for connecting a desired polarization of the signal received by the second antenna to the second output port.

2. The wireless antenna arrangement defined in claim 1 further including a controller responsive to a characteristic of signals received by the antennas for generating the control signal to cause a selected combination of received signals to be output by the controllable selection element.

3. The wireless antenna arrangement defined in claim 2 wherein each of the at least first and second antennas is a dual polarization aperture coupled patch antenna.

4. The wireless antenna arrangement defined in claim 2 wherein each of the at least first and second antennas is a set of orthogonal dipole antennas.

5. The wireless antenna arrangement defined in claim 1 further including a controller for monitoring a characteristic of signals received by the antennas and for generating the control signal to cause a selected combination of received signals to be output by the controllable selection element.

6. The wireless antenna arrangement defined in claim 5 wherein the controller also compares characteristics of signals received by the antennas during a predetermined monitoring period in order to determine the best characteristics received by the antennas and thereby to generate the control signal that selects the combination of received signals to be output by the controllable selection element.

7. The wireless antenna arrangement defined in claim 5 wherein each of the at least first and second antennas is a dual polarization aperture coupled patch antenna.

8. The wireless antenna arrangement defined in claim 5 wherein each of the at least first and second antennas is a set of orthogonal dipole antennas.

9. A wireless antenna arrangement comprising:
at least first and second antennas spaced apart from each other by a predetermined distance, each antenna having orthogonal elements for receiving first and second polarizations of a signal;
a controllable selection element coupled to each orthogonal element of the at least first and second antennas, the controllable selection element also including at least first and second input ports and being responsive to a control signal for connecting a signal at the first input port to a desired orthogonal element of the first antenna and for connecting a signal at the second input port to a desired orthogonal element of the second antenna.

10. The wireless antenna arrangement defined in claim 9 further including a controller for generating the control signal to cause a selected combination of received signals to be output by the controllable selection element.

11. The wireless antenna arrangement defined in claim 10 wherein each of the at least first and second antennas is a dual polarization aperture coupled patch antenna.

12. The wireless antenna arrangement defined in claim 10 wherein each of the at least first and second antennas is a set of orthogonal dipole antennas.

13. A method for improving communications in a wireless network, the method comprising the steps of:
receiving signals at a first and second dual polarized antenna to generate first and second output signals from each dual polarized antenna;
selecting a first combination of signals as input signals to a multi-input, multi-output (MIMO) receiver in response to a control signal, the combination of signals including one signal from the first and second output signals of the first dual polarized antenna and another signal from the first and second output signals of the second dual polarized antenna.

14. The method as defined in claim 13 further including the step of:
switching from the first combination of signals to a second combination of signals in response to the control signal, the second combination of signals including signals orthogonal to each of the one signal and the another signal.

15. The method as defined in claim 14 further including the steps of:
monitoring a characteristic of signals received by the antenna; and
generating the control signal in response to the characteristic being monitored.
